(19) United States
(12) Patent Application Publication
(10) Pub. No.: US 2024/0109098 A1
(43) Pub. Date: Apr. 4, 2024

(54) GLUE EXTRUDER DEVICE

(71) Applicant: Ryan Andrew WELTY, Cedar Rapids, IA (US)

(72) Inventor: Ryan Andrew WELTY, Cedar Rapids, IA (US)

(21) Appl. No.: 18/478,299

(22) Filed: Sep. 29, 2023

Related U.S. Application Data
(60) Provisional application No. 63/411,453, filed on Sep. 29, 2022.

(51) Int. Cl. B05C 5/02

(52) U.S. Cl. CPC B05C 5/027; B05C 5/0245

(57) ABSTRACT

A glue extruder device has a first body and a second body selectively attachable to one another through connecting members. The device has at least one stabilizing member preventing the second body from moving relative to the first body. The device utilizes a quick coupler along with spaces allowing quick detachment of the second body from the first body.

### CROSS-REFERENCE TO RELATED APPLICATIONS

This application claims priority to U.S. Provisional Application No. 63/411,453 filed on Sep. 29, 2022, the contents of which are hereby incorporated by reference herein.

### BACKGROUND

In certain industries, including sheet metal processing, the use of glue extruders is required for finished products. In many instances, a plurality of glue extruders are required to be placed on a machine. The current state of the art utilizes steel springs to assist with the connection of the two main parts of glue extruders. The steel spring also assists with maintaining the angular relationship between the two main parts. The steel spring is difficult to remove and attach. Accordingly, the time and costs of labor associated with the removal and attachment leads to longer hours and added expenses.

It is an object of the present invention to have the ability to have a glue extruder where the two main parts are easily separated and attached.

It is a further object of the invention to have a glue extruder device that can prevent angular or rotatable movement of two main bodies.

### SUMMARY OF THE INVENTION

The current invention is a glue extruder device that utilizes at least one rod along with a connector to allow a user to easily separate and attach a first body from a second body of the glue extruder device. The at least one rod helps maintain the angular position of the first body relative to the second body. Glue or some other liquid or gas can be supplied to the first body. As the first body and the second body are in communication with one another via passageways, the liquid or gas is forced into the second body and out predetermined openings in the second body.

### BRIEF DESCRIPTION OF THE DRAWINGS

FIG. 1 is a perspective view of the glue extruder device;

FIG. 2 is a top side view of the glue extruder device wherein the two main bodies are shown separated;

FIG. 3 is a bottom side view of the glue extruder device;

FIG. 4 is a right side view of the glue extruder device;

FIG. 5 is a left side view of the glue extruder device;

FIG. 6 is a front view of the glue extruder device;

FIG. 7 is a rear view of the glue extruder device;

FIG. 8 is a perspective view of the second body;

FIG. 9 is a side view of the second body;

FIG. 10 is a cross-sectional view of the second body with a first set of openings;

FIG. 11 is a front view of the second body;

FIG. 12 is a front view of the second body with alternate openings;

FIG. 13 is a side view of the second body;

FIG. 14 is a cross-sectional view of the second body showing alternate passageways;

FIG. 15 is a perspective view of the glue extruder device;

FIG. 16 is a cross-sectional view of the glue extruder device showing the stabilizing member connection to the second body.

### DETAILED DESCRIPTION

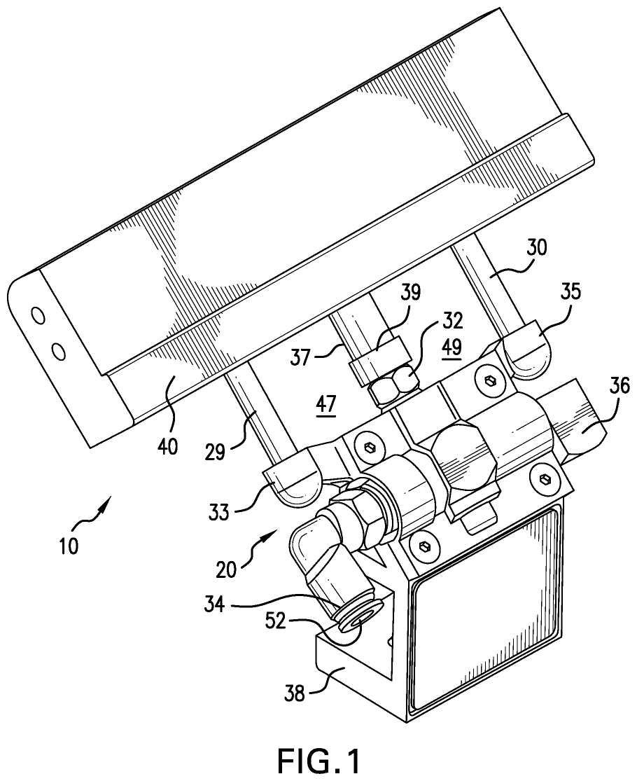

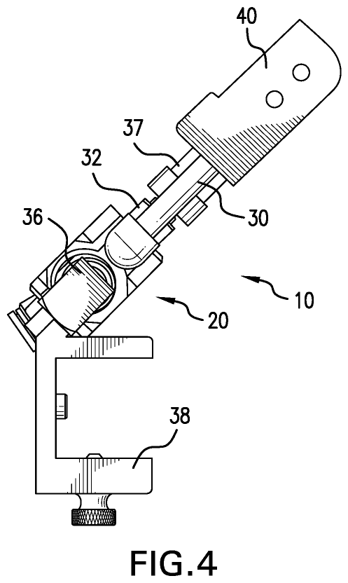

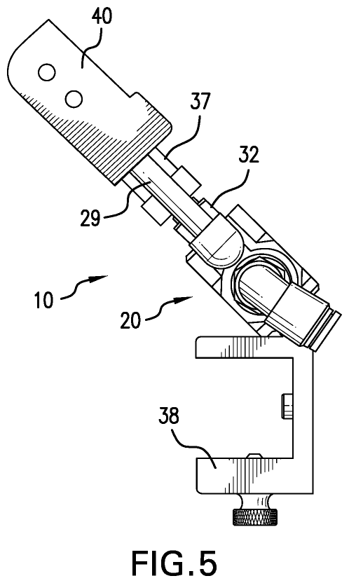

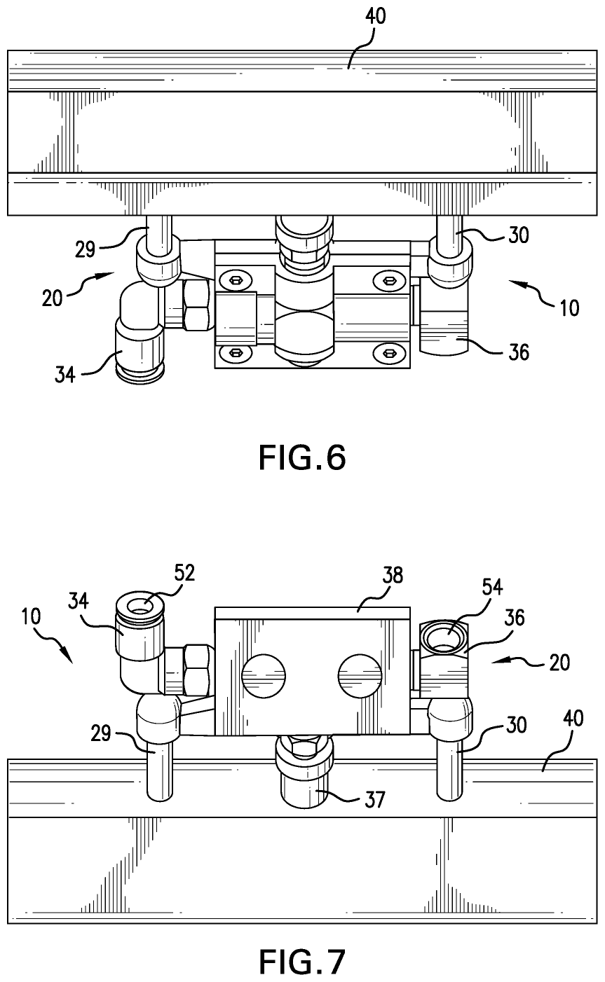

Now referring to the drawings, FIGS. 1, and 3-7 show a glue extruder device 10. The device 10 has a first body 20 and a second body 40. The first body 20 has a first stabilizing member 29 and a second stabilizing member 30 extending from the first body 20. A first end of each of the stabilizing members are secured to the first body 20, preferably in holders 33 and 35. The stabilizing members extend toward the second body 40 and are at least partially housed in the second body 40. A first connecting member 32 extends from the first body 20 toward a second connecting member 37.

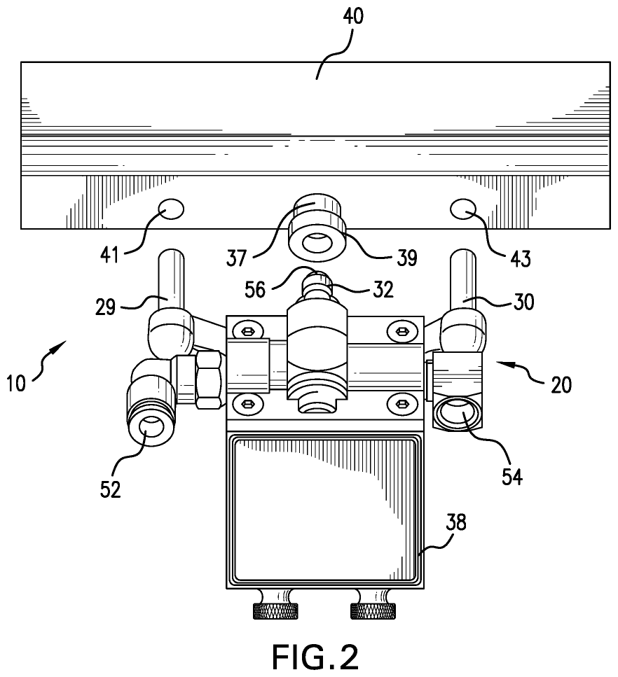

As shown in FIG. 2, the device 10 is shown separated into its first body 20 and second body 40. This view allows openings 41 and 43 to be seen. These openings 41 and 43 partially house the stabilizing members 29 and 30 respectively. The bodies 20 and 40 are separated by a user manipulating the second connecting member 37. In the preferred embodiment, the second connecting member 37 is a female quick coupler with a movable sleeve 39; and the first connecting member 32 is a male coupling nipple that can be selectively inserted into the second connecting member 37. When the two bodies 20 and 40 are in the connected state, a user can separate the bodies by pushing the sleeve 39 downward toward the second body 40 and pull the bodies 20 and 40 in opposite directions.

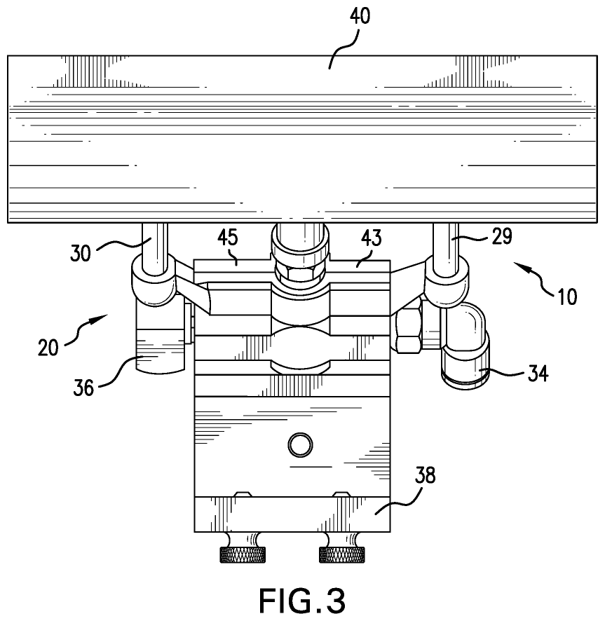

In order to assist a user in the separation of the bodies 20 and 40, the preferred embodiment utilizes specific placement of the stabilizing members 29 and 30 relative to the first connecting member 32, the first body 20 and the second body 40. As best seen in FIGS. 1 and 3, the stabilizing members 29 and 30 flank the first connecting member 32. A first surface 43 of the first body 20 is located between the first connecting member 32 and the first stabilizing member 29. The first surface 43 is large enough to accommodate a first finger of a user of the device. A second surface 45 of the first body 20 is located between the first connecting member 32 and the second stabilizing member 30. The second surface 45 is large enough to accommodate a second finger of a use of the device. In addition to the surfaces 43 and 45, a first space 47 is created between the first surface 43 and the second body 40. The first space 47 is large enough to allow the user to position the first finger in the first space 47 and then on the first surface 43. Similarly, a second space 49 is created between the second surface 45 and the second body 40. The second space 49 is large enough to allow the user to position the second finger in the second space 49 and then on the second surface 45.

Without the stabilizing members 29 and 30, the first body 20 could rotate relative to the second body 40. Once the stabilizing members 29 and 30 are guided into the openings 41 and 43 respectively, such movement, whether rotational or angular is prevented.

The device 10 has passageways or cavities in the first body 20, the connecting members 32 and 37, and the second body 40, all in fluid communication such that glue, fluid, gas, or some combination thereof can flow from the first body 20, through the connecting members 32 and 37, and then to the second body 40. As best shown in FIG. 7, the first body 20 has a first inlet 34 and a second inlet 36. The first inlet 34 has a passageway 52 that is at least partially in alignment or communication with a passageway 56 of the first connecting member 32. The second inlet 34 has a passageway 54 that is at least partially in alignment or communication with the passageway 56 of the first connecting member 32. Accordingly, the same materials or a combination of different materials can be manipulated through the first inlet 34 and the second inlet 36.

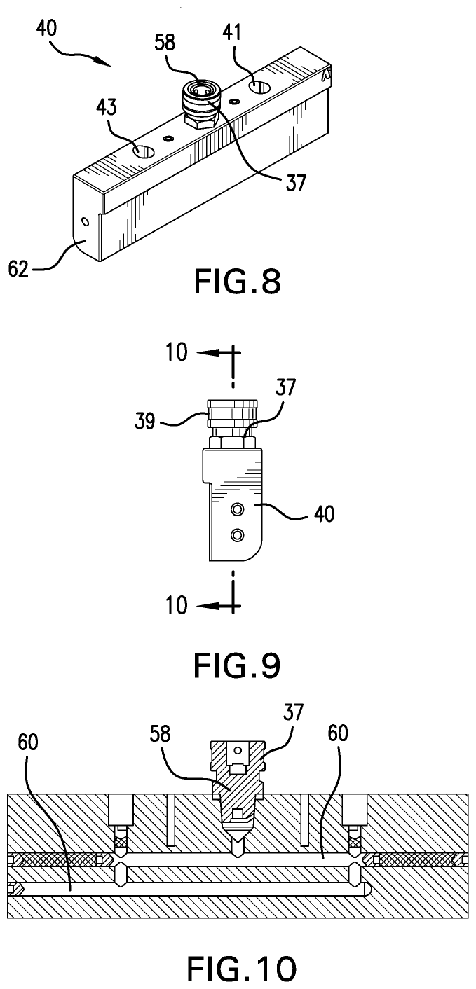

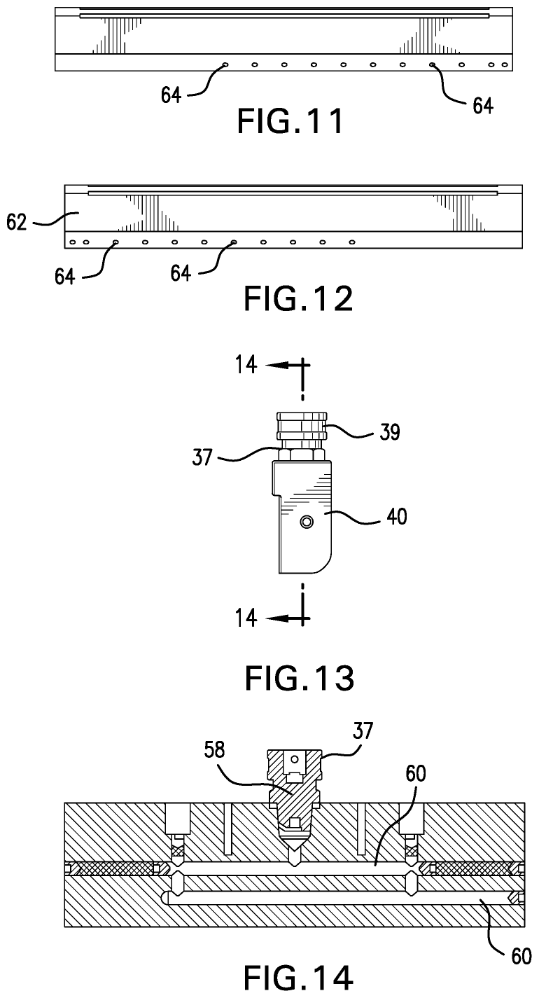

The second connecting member 37 has a passageway 58 that is at least partially in alignment or communication with the passageway 56 of the first connecting member 32. The passageway 58 of the second connecting member 37 is then in at least partial alignment or communication with ducts 60 in a head 62 of the second body 40. The ducts 60 lead to openings 64 where the glue, fluid, air or some combination thereof exits the device 10 onto a surface that needs said materials exiting the openings 64. The openings 64 and the ducts 60 can be put in a specific pattern such that glue comes out on a particular side of the head 62. FIGS. 8-11 show one such configuration, while FIGS. 12-14 show a second configuration that is opposite of the first configuration.

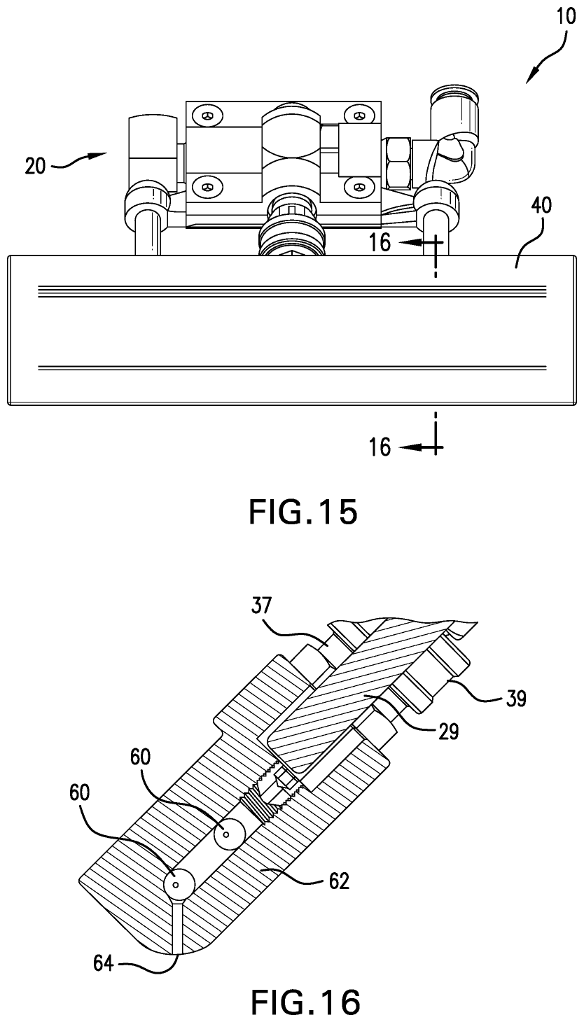

FIGS. 15 and 16 illustrate a different perspective of the ducts 60 and an opening 64. As detailed above, glue, fluid, gas or some combination can flow from the first body 20 and make their way to the openings 64 of the head 62. The device 10 preferably includes the mounting member 38 that can be attached to another structure. The mounting member 38 can be part of the first body 20 or extend outwardly therefrom.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is:

1. A glue extruder device, comprising:
a first body;
a second body;
the first body having a first connecting member;
the second body having a second connecting member;
the first connecting member selectively attachable to the second connecting member.

2. The glue extruder device of claim 1, further comprising:
a first stabilizing member;
the first stabilizing member selectively receivable by the second body.

3. The glue extruder device of claim 2, further comprising:
a second stabilizing member;
the second stabilizing member selectively receivable by the second body.

4. The glue extruder device of claim 3, wherein:
the first connecting member is positioned between the first stabilizing member and the second stabilizing member.

5. The glue extruder device of claim 4, further comprising:
a first surface of the first body;
the first surface located between the first stabilizing member and the first connecting member.

6. The glue extruder device of claim 5, further comprising:
a second surface of the first body;
the second surface located between the second stabilizing member and the first connecting member.

7. The glue extruder device of claim 6, further comprising:
a first space;
the first space located between the first surface and the second body;
the first space configured to allow a finger of a user of the device to be placed in the first space and contacting the first surface.

8. The glue extruder device of claim 7, further comprising:
a second space;
the second space located between the second surface and the second body;
the second space configured to allow a second finger of a user of the device to be placed in the second space and contacting the second surface.

9. The glue extruder device of claim 8, wherein:
the first body has a first inlet;
the first inlet has a passageway;
the first connecting member has a passageway;
the passageway of the first inlet and the passageway of the first connecting member at least partially in alignment as configured to allow a gas or fluid to pass through.

10. The glue extruder device of claim 9, wherein:
the second connecting member has a passageway;
the passageway of the first connecting member and the passageway of the second connecting member at least partially in alignment as configured to allow a gas or fluid to pass through.

11. The glue extruder device of claim 10, wherein:
the second body has a head;
the head has at least one duct leading to a plurality of openings on the head.

12. The glue extruder device of claim 11, wherein:
the first connecting member is a male coupling nipple.

13. The glue extruder device of claim 12, wherein:
the second connecting member is a female quick coupler with a movable sleeve;
wherein the sleeve is moved in a first direction to allow the second connecting member to disengage from the first connecting member.

14. A glue extruder device, comprising:
a first body;
a second body;
the first body has a first connecting member;
the second body has a second connecting member;
the first connecting member selectively attachable to the second connecting member;
a first stabilizing member extending from the first body;
a second stabilizing member extending from the first body;
a portion of the first stabilizing member receivable by the second body;
a portion of the second stabilizing member receivable by the second body;
wherein the device is configured for a fluid or gas to pass from the first body to the second body.

15. The glue extruder of claim 14, wherein:
the first connecting member is positioned between the first stabilizing member and the second stabilizing member;
a first surface of the first body;
the first surface located between the first stabilizing member and the first connecting member;
a second surface of the first body;
the second surface located between the second stabilizing member and the first connecting member.

16. The glue extruder device of claim 15, further comprising:
a first space;
the first space located between the first surface and the second body;
the first space configured to allow a finger of a user of the device to be placed in the first space and contacting the first surface.

17. The glue extruder device of claim 16, further comprising:
a second space;
the second space located between the second surface and the second body;
the second space configured to allow a second finger of a user of the device to be placed in the second space and contacting the second surface.

18. The glue extruder device of claim 17, wherein:
the first body has a first inlet;
the first inlet has a passageway;
the first connecting member has a passageway;
the passageway of the first inlet and the passageway of the first connecting member at least partially in alignment as configured to allow a gas or fluid to pass through;
the second connecting member has a passageway;
the passageway of the first connecting member and the passageway of the second connecting member at least partially in alignment as configured to allow a gas or fluid to pass through;
the second body has a head;
the head has at least one duct leading to a plurality of openings on the head.

19. The glue extruder device of claim 18, wherein:
the first connecting member is a male coupling nipple;
the second connecting member is a female quick coupler with a movable sleeve;
wherein the sleeve is moved in a first direction to allow the second connecting member to disengage from the first connecting member.

20. A glue extruder device, comprising:
a first body;
a second body;
the first body has a first connecting member;
the second body has a second connecting member;
the first connecting member selectively attachable to the second connecting member;
the first connecting member is a male coupling nipple;
the second connecting member is a female quick coupler with a movable sleeve;
wherein the sleeve is moved in a first direction to allow the second connecting member to disengage from the first connecting member;
at least one stabilizing member extending from the first body and receivable by the second body wherein the at least one stabilizing member prevents rotating movement of the second body.
